(19) United States
(12) Patent Application Publication
(10) Pub. No.: US 2011/0149718 A1
(43) Pub. Date: Jun. 23, 2011

(54) FAST FOURIER TRANSFORM APPARATUS AND METHOD

(75) Inventor: Young-Ha LEE, Daejeon-si (KR)

(73) Assignee: Electronics and Telecommunications Reasearch Institute, Daejeon (KR)

(21) Appl. No.: 12/841,493

(22) Filed: Jul. 22, 2010

(30) Foreign Application Priority Data
Dec. 18, 2009 (KR) 10-2009-0127317

(51) Int. Cl. H04J 11/00

(52) U.S. Cl. 370/210

(57) ABSTRACT

A fast Fourier transform (FFT) apparatus and method. The FFT method may include finding a number of subcarriers carrying valid data in reception data, determining a Fourier transform order on the basis of the number of subcarriers, performing complex multiplication on the reception data, and then performing a Fourier transform of the determined Fourier transform order. Using the FFT method, it is possible to reduce the amount of computation and the complexity of an FFT in a frequency division multiplexing (FDM) system and simplify a hardware structure.

### CROSS-REFERENCE TO RELATED APPLICATION

This application claims the benefit under 35 U.S.C. §119(a) of Korean Patent Application No. 10-2009-0127317, filed on Dec. 18, 2009, the entire disclosure of which is incorporated herein by reference for all purposes.

### BACKGROUND

1. Field

The following description relates to fast Fourier transform (FFT), and more particularly, to an FFT apparatus and method in an orthogonal frequency division multiplexing (OFDM) communication method.

2. Description of the Related Art

A Fourier transform process is necessary for an OFDM transmission method. To reduce the amount of computation for a Fourier transform, an FFT algorithm has been suggested. An uplink random access channel of a third generation partnership project (3GPP)-long term evolution (LTE) system requires a 24576-point inverse FFT (IFFT), the actual computation of which is complex and extensive. To solve these problems, a technique for implementing a small-point IFFT has been suggested. In an example method, a time-domain interpolation filter is used and frequency switching is performed. However, in this method, the number of filter taps is limited, and the coefficient is not accurate. Consequently, it is still difficult to perform an accurate 24576-point IFFT.

### SUMMARY

The following description relates to a fast Fourier transform (FFT) apparatus and method capable of reducing the amount of computation for an actual FFT and the complexity of the FFT by implementing a small-point FFT.

In one general aspect, there is provided a fast Fourier transform (FFT) method including: finding a number of subcarriers carrying valid data in reception data; determining a Fourier transform order on the basis of the number of subcarriers; performing complex multiplication on the reception data; and performing a Fourier transform of the determined Fourier transform order after performing complex multiplication.

The determining of the Fourier transform order may include determining a minimum among divisors of a number of all subcarriers of the reception data, which is greater than the number of the subcarriers carrying the valid data, as the Fourier transform order.

The FFT method may further include, after the performing of the Fourier transform, performing complex multiplication on a result of the Fourier transform.

In another general aspect, there is provided a fast Fourier transform (FFT) apparatus is including: an order determiner finding a number of subcarriers carrying valid data in reception data, and determining a Fourier transform order on the basis of the number of subcarriers; a complex multiplier performing complex multiplication on the reception data; and a Fourier transformer performing a Fourier transform of the determined Fourier transform order on a result value of the complex multiplier.

Additional aspects of the invention will be set forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the aspects of the invention.

FIG. 1 is a block diagram of a fast Fourier transform (FFT) apparatus according to an exemplary embodiment of the present invention.

FIG. 2 illustrates operation of an FFT apparatus according to an exemplary embodiment of the present invention in detail.

FIG. 3 is a block diagram of an FFT apparatus according to another exemplary embodiment of the present invention.

FIG. 4 illustrates operation of the FFT apparatus according to the other exemplary embodiment of the present invention shown in FIG. 3 in detail.

FIGS. 5 and 6 show examples of an N-point Fourier transform apparatus according to an is exemplary embodiment of the present invention.

FIG. 7 is a flowchart illustrating an FFT method according to an exemplary embodiment of the present invention.

FIG. 8 is a flowchart illustrating an FFT method according to another exemplary embodiment of the present invention.

### DETAILED DESCRIPTION

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

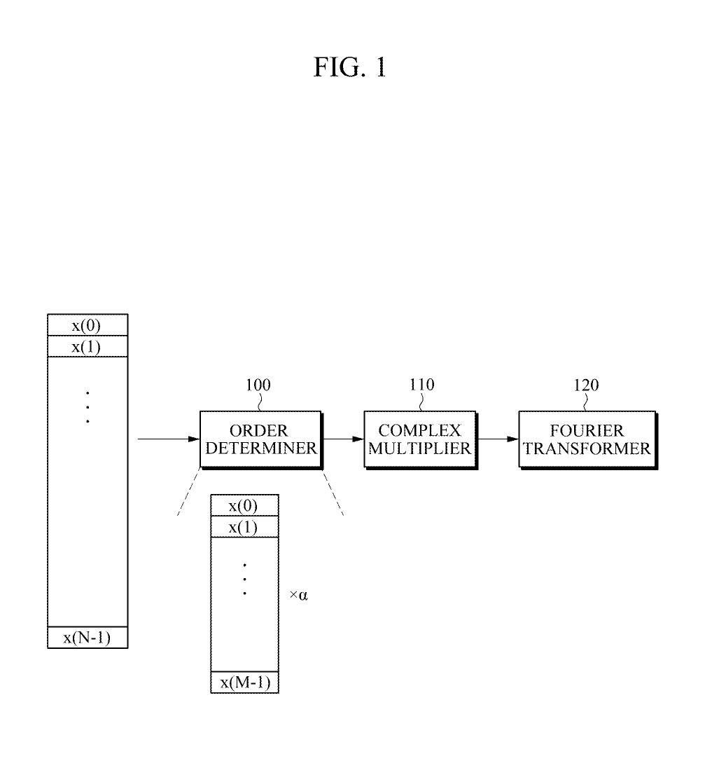

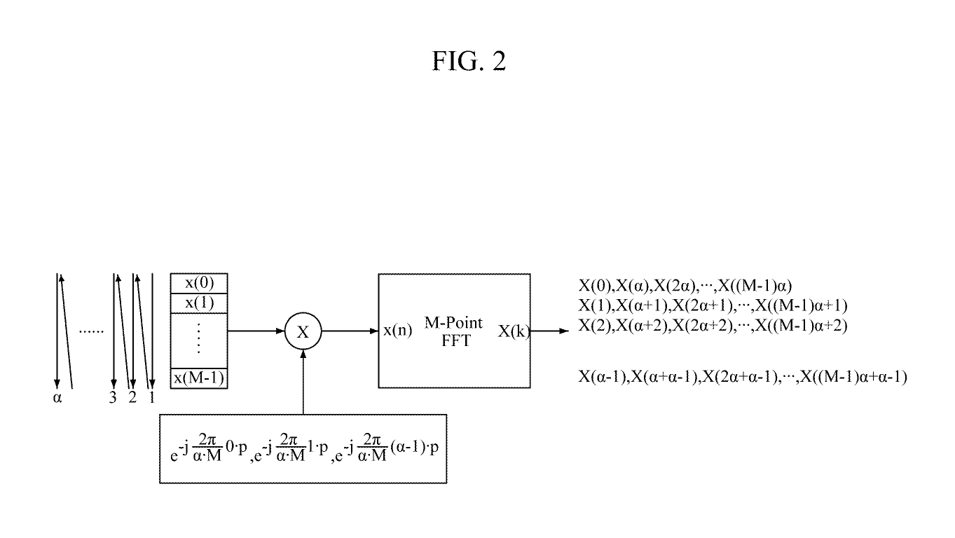

FIG. 1 is a block diagram of a fast Fourier transform (FFT) apparatus according to an exemplary embodiment of the present invention, and FIG. 2 illustrates operation of an FFT apparatus according to an exemplary embodiment of the present invention in detail.

As shown in the drawings, an FFT apparatus according to an exemplary embodiment of the present invention includes an order determiner 100, a complex multiplier 110, and a Fourier transformer 120.

The order determiner 100 receives an orthogonal frequency division multiplexing (OFDM) signal having a total of N subcarriers, and finds how many subcarriers among the N subcarriers of reception data are valid carriers on which valid data is actually carried. Here, the valid carriers are not null-subcarriers but carriers actually carrying valid data.

Also, the order determiner 100 determines a Fourier transform order M on the basis of is the number of the valid carriers. Here, the Fourier transform order M is less than the number N of all subcarriers and greater than the number of the valid carriers. According to one aspect, the order determiner 100 determines the minimum among divisors of N, which is greater than the number of the valid carriers, as the Fourier transform order M.

The complex multiplier 110 performs complex multiplication on the reception data. In one exemplary embodiment, the complex multiplier 110 multiplies each piece of carrier data included in the reception data by

$${e}^{- j \frac{2 π}{α \cdot M} p} .$$

Here, p denotes the sequential information of the corresponding carrier obtained by dividing the number of all carriers of the reception data by the transform order M.

The Fourier transformer 120 performs an M-point Fourier transform on pieces of the data complex multiplied by the complex multiplier 110.

Examples of data values obtained by the respective aforementioned technical components are shown in FIG. 2.

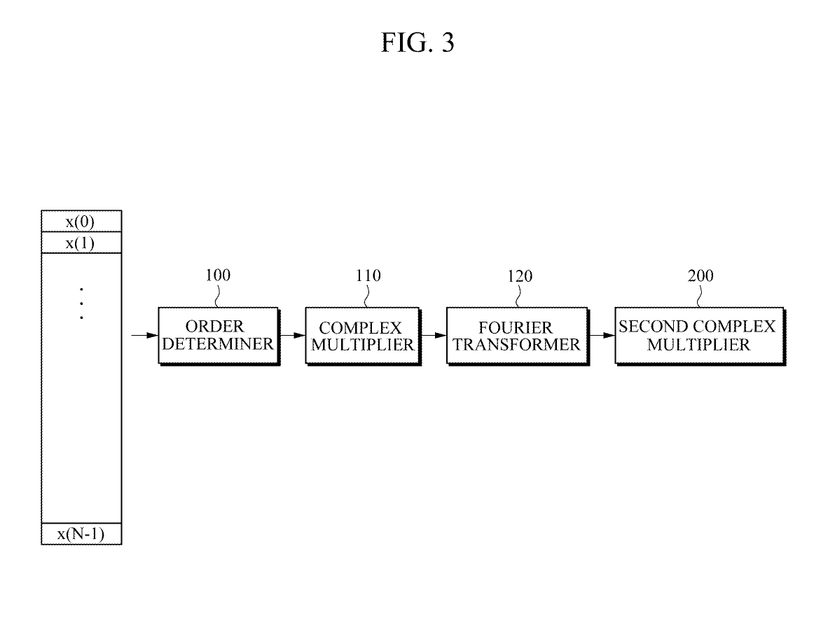

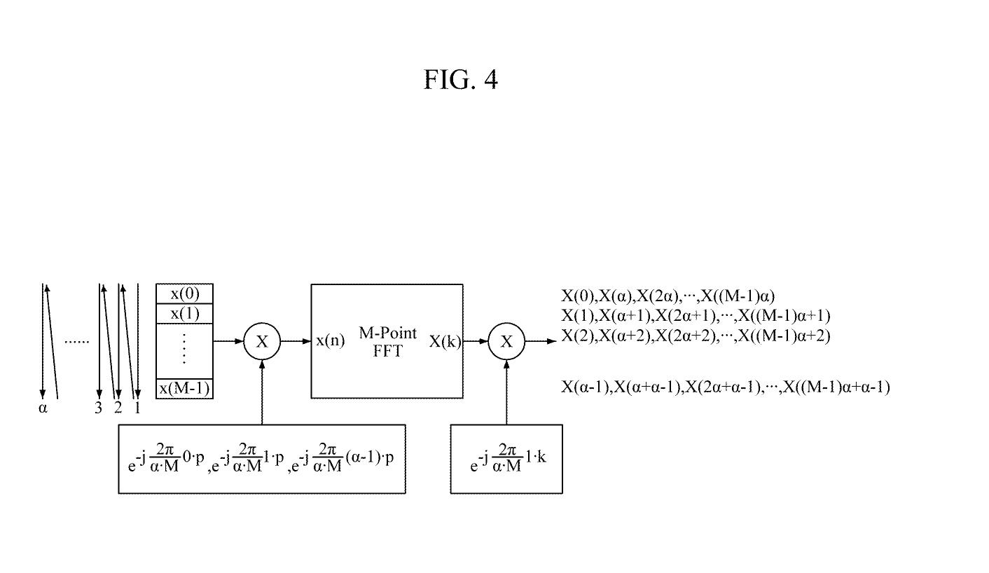

FIG. 3 is a block diagram of an FFT apparatus according to another exemplary embodiment of the present invention, and FIG. 4 illustrates operation of the FFT apparatus according to the other exemplary embodiment of the present invention shown in FIG. 3 in detail.

As shown in FIG. 3, a second complex multiplier 200 can be additionally included on the output terminal side of a Fourier transformer 120. In an exemplary embodiment, the second complex multiplier 200 can be implemented the same as the aforementioned complex multiplier 110.

Examples of data values obtained by the respective aforementioned components are shown in FIG. 4.

A method of determining a Fourier transform order will be described in detail below is In general, an N-point fast Fourier transformer operates according to Equation 1 below.

$$X ( k ) = {\sum }_{n = 0}^{N - 1} x ( n ) {e}^{- j \frac{2 π}{N} kn} , k = 0 , 1 , 2 , … , N - 1 \qquad [ Equation 1 ]$$

In Equation 1, N input values are Fourier transformed and output as N output values. However, valid data may not be carried on all the N input values, and a null value may be carried on some of the N input values.

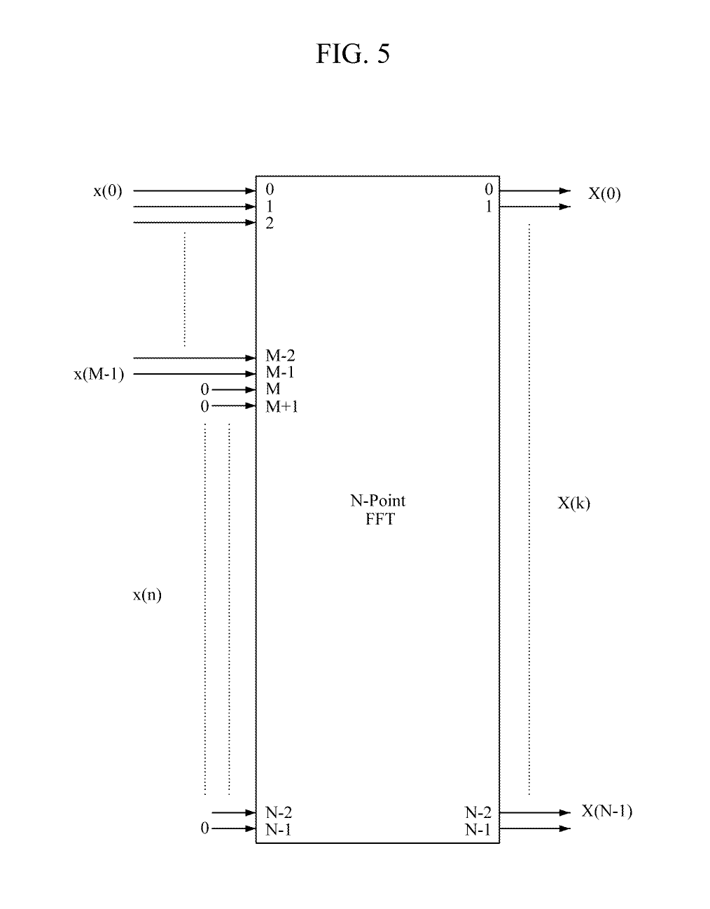

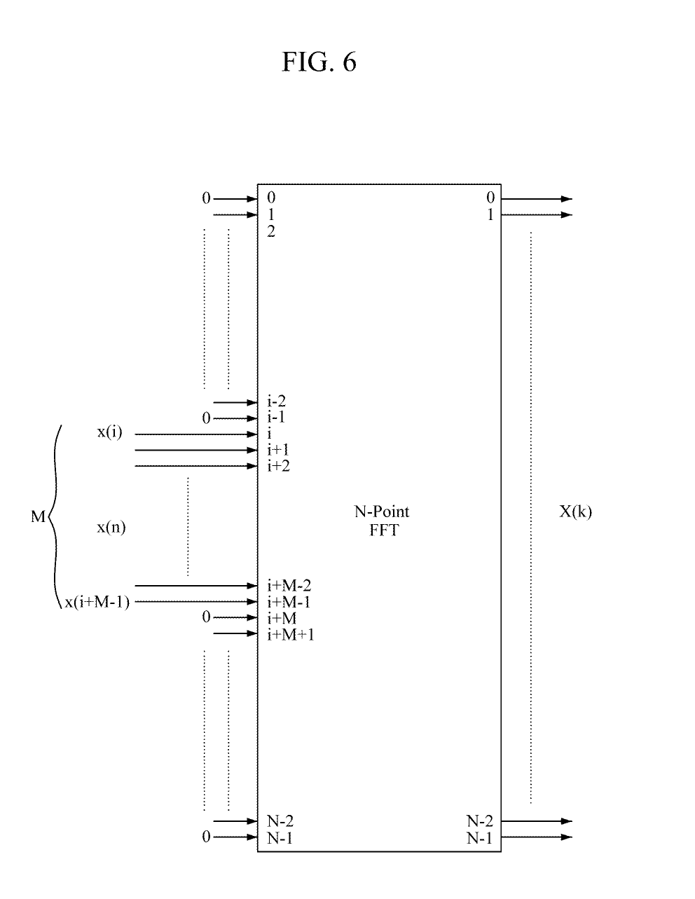

FIGS. 5 and 6 show examples of an N-point Fourier transform apparatus according to an exemplary embodiment of the present invention. As shown in FIG. 5, when “0” is included in a part of input reception data, Equation 1 can be changed into Equation 2 below.

$$\begin{matrix}X ( k ) = {\sum }_{n = 0}^{N - 1} x ( n ) \cdot {e}^{- j \frac{2 π}{N} kn} \\ = x ( 0 ) \cdot {e}^{- j \frac{2 π}{N} k 0} + x ( 1 ) \cdot {e}^{- j \frac{2 π}{N} k 1} + … + \\ x ( M - 1 ) \cdot {e}^{- j \frac{2 π}{N} k 0} + x ( M ) \cdot {e}^{- j \frac{2 π}{N} k M} … + \\ x ( N - 1 ) \cdot {e}^{- j \frac{2 π}{N} k ( N - 1 )} \\ = x ( 0 ) \cdot {e}^{- j \frac{2 π}{N} k 0} + x ( 1 ) \cdot {e}^{- j \frac{2 π}{N} k 1} + … + \\ x ( M - 1 ) \cdot {e}^{- j \frac{2 π}{N} k 0} + 0 \cdot {e}^{- j \frac{2 π}{N} k M} + … + \\ 0 \cdot {e}^{- j \frac{2 π}{N} k ( N - 1 )} \\ = x ( 0 ) \cdot {e}^{- j \frac{2 π}{N} k 0} + x ( 1 ) \cdot {e}^{- j \frac{2 π}{N} k 1} + … + \\ x ( M - 1 ) \cdot {e}^{- j \frac{2 π}{N} k 0} \\ = {\sum }_{p = 0}^{M - 1} x ( p ) \cdot {e}^{- j \frac{2 π }{N} kp}\end{matrix} \qquad [ Equation 2 ]$$

Here, the number of carriers on which valid data is actually carried is always less than the number N of all pieces of input data. For example, when N is 24576 and the number of carriers on which valid data is actually carried is 864, the Fourier transform order M can be set to an integer divisor of N. For example, the Fourier transform order M can be set to 1024, which is greater than the number of carriers on which valid data is carried and is an integer divisor of N. Thus, N is 24 times greater than M. The order determiner 100 puts as many “0”s as a difference obtained by subtracting 864 from 1024 on carriers.

In other words, a relational expression between N and the Fourier transform order M can be expressed as follows:

N=α·M, α≧1, α:integer [Equation 3]

When the relationship between M and N of Equation 3 is applied to Equation 2, Equation 4 is obtained.

$$\begin{matrix}\begin{matrix}X ( k ) = {\sum }_{p = 0}^{M - 1} x ( p ) \cdot {e}^{- j \frac{2 π}{N} kp} \\ = {\sum }_{p = 0}^{M - 1} x ( p ) \cdot {e}^{- j \frac{2 π}{α M} kp}\end{matrix} & [ Equation 4 ] \\ ( where k = 0 , 1 , 2 , … , and N - 1 ) & \end{matrix}$$

In an exemplary embodiment, terms of an output X(k) can be classified as follows:

X(α·k′), X(α·k′+1), X(α·k′+2), . . . , X(α·k′+α−1)

Here, k′=0, 1, 2, . . . , M−1. When k′ is applied to Equation 4, Equation 5 can be obtained.

$$\begin{matrix}X ( α \cdot {k}^{′} ) = {\sum }_{p = 0}^{M - 1} x ( p ) \cdot {e}^{- j \frac{2 π}{α M} α {k}^{′} p} \\ = {\sum }_{p = 0}^{M - 1} x ( p ) \cdot {e}^{- j \frac{2 π}{ M} {k}^{′} p}\end{matrix} \\ \begin{matrix}X ( α \cdot {k}^{′} + 1 ) = {\sum }_{p = 0}^{M - 1} x ( p ) \cdot {e}^{- j \frac{2 π}{α M} α ( {k}^{′} + 1 ) p} \\ = {\sum }_{p = 0}^{M - 1} x ( p ) \cdot {e}^{- j \frac{2 π}{ M} {k}^{′} p} \cdot {e}^{- j \frac{2 π}{α M} p}\end{matrix} \\ \begin{matrix}X ( α \cdot {k}^{′} + 2 ) = {\sum }_{p = 0}^{M - 1} x ( p ) \cdot {e}^{- j \frac{2 π}{α M} α ( {k}^{′} + 2 ) p} \\ = {\sum }_{p = 0}^{M - 1} x ( p ) \cdot {e}^{- j \frac{2 π}{ M} {k}^{′} p} \cdot {e}^{- j \frac{2 π}{α M} 2 p}\end{matrix} \\ … \\ \begin{matrix}X ( α \cdot {k}^{′} + α - 1 ) = {\sum }_{p = 0}^{M - 1} x ( p ) \cdot {e}^{- j \frac{2 π}{α M} α ( {k}^{′} + α - 1 ) p} \\ = {\sum }_{p = 0}^{M - 1} x ( p ) \cdot {e}^{- j \frac{2 π}{ M} {k}^{′} p} \cdot {e}^{- j \frac{2 π}{α M} ( α - 1 ) p}\end{matrix} \qquad [ Equation 5 ]$$

As a result, X(α·k′) is obtained by an M-point Fourier transformer. In other words, the Fourier transformer 120 can perform an M-point Fourier transform.

Thus, the complex multiplier 110 multiplies the reception data by

$${e}^{- j \frac{2 π}{α M} p} ,$$

and the Fourier transformer 120 performs an M-point Fourier transform so that X(α·k′+1) can be obtained.

Likewise, X(α·k′+α−1) can be obtained by multiplying an input by

$${e}^{- j \frac{2 π}{α M} ( α - 1 ) p}$$

and performing an M-point Fourier transform on the product of the input and

$${e}^{- j \frac{2 π}{α M} ( α - 1 ) p} .$$

As a result, by performing an M-point Fourier transform α times, it is possible to obtain the same result as by performing an N-point Fourier transform.

Meanwhile, as shown in FIG. 6, when carriers containing “0” are input at positions different from those in FIG. 5, and a carrier containing valid data other than “0” is received at an i-th order or later, Equation 2 can be generalized as Equation 6 below.

$$\begin{matrix}X ( k ) = {\sum }_{n = 0}^{N - 1} x ( n ) \cdot {e}^{- j \frac{2 π}{N} kn} \\ = x ( 0 ) \cdot {e}^{- j \frac{2 π}{N} k 0} + x ( 1 ) \cdot {e}^{- j \frac{2 π}{N} k 1} + … x ( i ) \cdot \\ {e}^{- j \frac{2 π}{N} k i} + … + x ( i + M - 1 ) \cdot \\ {e}^{- j \frac{2 π}{N} k ( i + M - 1 )} + … + x ( N - 1 ) \cdot {e}^{- j \frac{2 π}{N} k ( N - 1 )} \\ = 0 \cdot {e}^{- j \frac{2 π}{N} k 0} + 0 \cdot {e}^{- j \frac{2 π}{N} k 1} + … + \\ x ( i ) \cdot {e}^{- j \frac{2 π}{N} k i} + … + x ( i + M - 1 ) \cdot \\ {e}^{- j \frac{2 π}{N} k ( i + M - 1 )} + … + 0 \cdot {e}^{- j \frac{2 π}{N} k ( N - 1 )} \\ = x ( i ) \cdot {e}^{- j \frac{2 π}{N} k i} + x ( i + 1 ) \cdot {e}^{- j \frac{2 π}{N} k ( i + 1 )} + … + \\ x ( i + M - 1 ) \cdot {e}^{- j \frac{2 π}{N} k ( i + M - 1 )} \\ = {\sum }_{p = 0}^{M - 1} x ( i + p ) \cdot {e}^{- j \frac{2 π }{N} k ( i + p )}\end{matrix} \qquad [ Equation 6 ]$$

Here, an input x(i+p) can be considered the same as x(p). Thus, Equation 6 can be reduced to Equation 7.

$$\begin{matrix}X ( k ) = {\sum }_{p = 0}^{M - 1} x ( i + p ) {e}^{- j \frac{2 π}{a \cdot M} k ( i + p )} \\ = {e}^{- j \frac{2 π}{a \cdot M} ki} \cdot {\sum }_{p = 0}^{M - 1} x ( p ) {e}^{- j \frac{2 π}{a \cdot M} kp}\end{matrix} \qquad [ Equation 7 ]$$

In comparison with Equation 4 above, an M-point FFT output is multiplied by

$${e}^{- j \frac{2 π}{α M} kp}$$

in Equation 7. When a carrier on which valid data is carried is received from the beginning as shown in FIG. 5, i is equal to 0, and thus the M-point FFT output is multiplied by

$${e}^{- j \frac{2 π}{α M} k 0} = 1.$$

As a result, the complex multiplier 110 is added on the input terminal side of the M-point Fourier transformer 120 capable of implementing an N-point FFT using an M-point FFT, and the second complex multiplier 200 is further added on the output terminal side of the Fourier transformer 120, so that an FFT apparatus capable of performing M-point Fourier transform even if a carrier on which valid data is carried is received after some reception data is input can be realized.

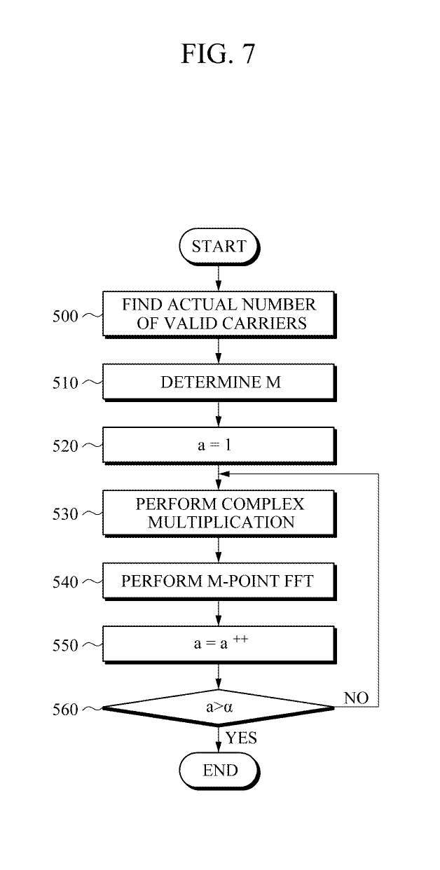

FIG. 7 is a flowchart illustrating an FFT method according to an exemplary embodiment of the present invention.

First, the number of valid carriers on which valid data is actually carried among carriers of reception data is found (500). On the basis of the number of valid carriers, a Fourier transform order M is determined (510). Here, the Fourier transform order M is less than a number N of all carriers and greater than the number of the valid carriers. According to an aspect, the order determiner 100 determines the minimum of divisors of N, which is greater than the number of the valid carriers, as the Fourier transform order M.

Subsequently, complex multiplication is performed on the reception data (530). In an exemplary embodiment, each piece of carrier data included in the reception data is multiplied by

$${e}^{- j \frac{2 π}{α \cdot M} p} .$$

Here, p denotes the sequential information of the corresponding carrier obtained by dividing the number of all carriers of the reception data by the transform order M.

Then, an M-point Fourier transform is performed on pieces of the complex multiplied data by the complex multiplier 110 (540). At this time, a process of performing complex multiplication on the reception data and performing N-point Fourier transform on the product needs to be performed a times (520, 550 and 560). Here, α is an integer obtained by dividing N by M.

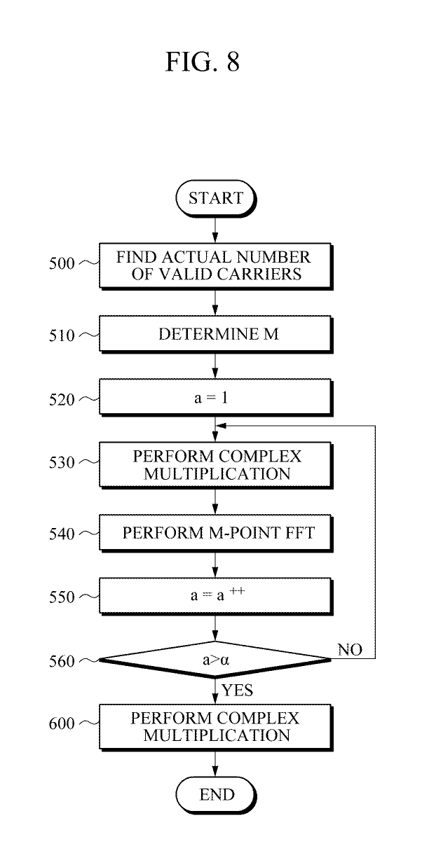

FIG. 8 is a flowchart illustrating an FFT method according to another exemplary embodiment of the present invention.

As illustrated in the drawing, complex multiplication is further performed on data that is is Fourier transformed and output (600), so that an FFT apparatus capable of performing M-point Fourier transform even if a carrier on which valid data is carried is received after some reception data is input can be realized.

As described above, an exemplary embodiment of the present invention can reduce the amount of computation and the complexity of an FFT in an OFDM system and simplify a hardware structure. In other words, low power design is enabled, and the efficiency of the structure can be improved.

The exemplary embodiments of the present invention can also be embodied as computer-readable codes on a computer-readable recording medium. Codes and code segments constituting the programs can be easily deduced by computer programmers skilled in the art. The computer-readable recording medium is any data storage device that can store data which can be thereafter read by a computer system. Examples of the computer-readable recording medium include read-only memories (ROMs), random-access memories (RAMs), CD-ROMs, magnetic tapes, floppy disks, and optical data storage devices. The computer-readable recording medium can also be distributed over network connected computer systems so that the computer-readable code is stored and executed in a distributed fashion.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A fast Fourier transform (FFT) method, comprising:
finding a number of subcarriers carrying valid data in reception data;
determining a Fourier transform order on the basis of the number of subcarriers;
performing complex multiplication on the reception data; and
performing a Fourier transform of the determined Fourier transform order after performing complex multiplication.

2. The FFT method of claim 1, wherein the determining of the Fourier transform order includes determining a minimum among divisors of a number of all subcarriers of the reception data, which is greater than the number of the subcarriers carrying the valid data, as the Fourier transform order.

3. The FFT method of claim 1, further comprising, after the performing of the Fourier transform, performing complex multiplication on a result of the Fourier transform.

4. The FFT method of claim 2, wherein the performing of the Fourier transform includes repeatedly performing the Fourier transform as many times as a value obtained by dividing the number of all the subcarriers of the reception data by the determined transform order.

5. The FFT method of claim 1, further comprising setting a data value of a subcarrier not carrying the valid data in the reception data to 0.

6. A fast Fourier transform (FFT) apparatus, comprising:
an order determiner finding a number of subcarriers carrying valid data in reception data, and determining a Fourier transform order on the basis of the number of subcarriers;
a complex multiplier performing complex multiplication on the reception data; and
a Fourier transformer performing a Fourier transform of the determined Fourier transform order on a result value of the complex multiplier.

7. The FFT apparatus of claim 6, wherein the order determiner determines a minimum among divisors of a number of all subcarriers of the reception data, which is greater than the number of the subcarriers carrying the valid data, as the Fourier transform order.

8. The FFT apparatus of claim 6, further comprising a second complex multiplier performing complex multiplication on a result value of the Fourier transformer.

9. The FFT apparatus of claim 7, wherein the Fourier transformer repeatedly performs is the Fourier transform as many times as a value obtained by dividing the number of all the subcarriers of the reception data by the determined transform order.

10. The FFT apparatus of claim 6, wherein the order determiner sets a data value of a subcarrier not carrying the valid data in the reception data to 0.
